(19) United States
(12) Patent Application Publication
(10) Pub. No.: US 2021/0122184 A1
(43) Pub. Date: Apr. 29, 2021

(54) Retractable Marker Assembly

(71) Applicant: Nene Agbeyteye, La Mesa, CA (US)

(72) Inventor: Nene Agbeyteye, La Mesa, CA (US)

(21) Appl. No.: 16/667,354

(22) Filed: Oct. 29, 2019

(51) Int. Cl. B43K 24/08; B43K 8/00; B43K 8/04; B43K 8/03; B43K 1/12

(52) U.S. Cl. CPC B43K 24/08; B43K 8/003; B43K 1/12; B43K 8/03; B43K 8/04

(57) ABSTRACT

A retractable marker assembly includes a tube that has a tapered end such that the tube has a conical shape. An ink cartridge is insertable into the tube and the ink cartridge contains a fluid ink. The ink cartridge is slidable between an extended position or a retracted position. An applicator is fluidly coupled to the ink cartridge to absorb the fluid ink contained in the ink cartridge for marking a surface. A cap is removably attached to the tube and a button slidably extends through the cap. The button engages the ink cartridge and the ink cartridge is positioned in the extended position exposed when the button is depressed having the applicator being exposed. The ink cartridge is positioned in the retracted position when the button is not depressed having the applicator being withdrawn into the tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to marker devices and more particularly pertains to a new marker device for filling in answer bubbles on a questionnaire.

### (2) Description of Related Art Including Information Disclosed Under 37 CFR 1.97 and 1.98

The prior art relates to marker devices.

### BRIEF SUMMARY OF THE INVENTION

An embodiment of the disclosure meets the needs presented above by generally comprising a tube that has a tapered end such that the tube has a conical shape. An ink cartridge is insertable into the tube and the ink cartridge contains a fluid ink. The ink cartridge is slidable between an extended position or a retracted position. An applicator is fluidly coupled to the ink cartridge to absorb the fluid ink contained in the ink cartridge for marking a surface. A cap is removably attached to the tube and a button slidably extends through the cap. The button engages the ink cartridge and the ink cartridge is positioned in the extended position exposed when the button is depressed having the applicator being exposed. The ink cartridge is positioned in the retracted position when the button is not depressed having the applicator being withdrawn into the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a retractable marker assembly according to an embodiment of the disclosure.

FIG. 2 is a front view of an embodiment of the disclosure.

FIG. 3 is a perspective in-use view of an embodiment of the disclosure.

FIG. 4 is an exploded perspective view of an embodiment of the disclosure.

FIG. 5 is a cross sectional view taken along line 5-5 of FIG. 1 of an embodiment of the disclosure.

### DETAILED DESCRIPTION OF THE INVENTION

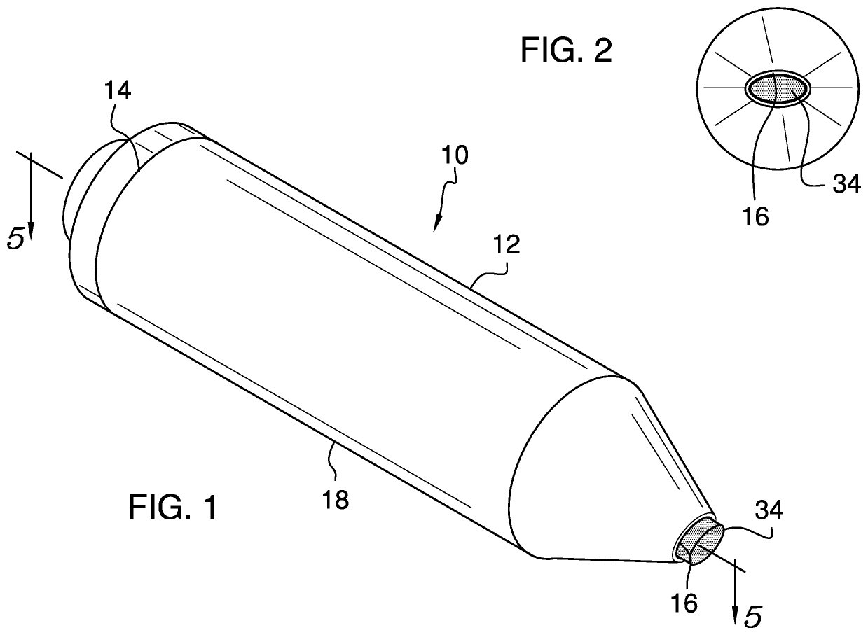

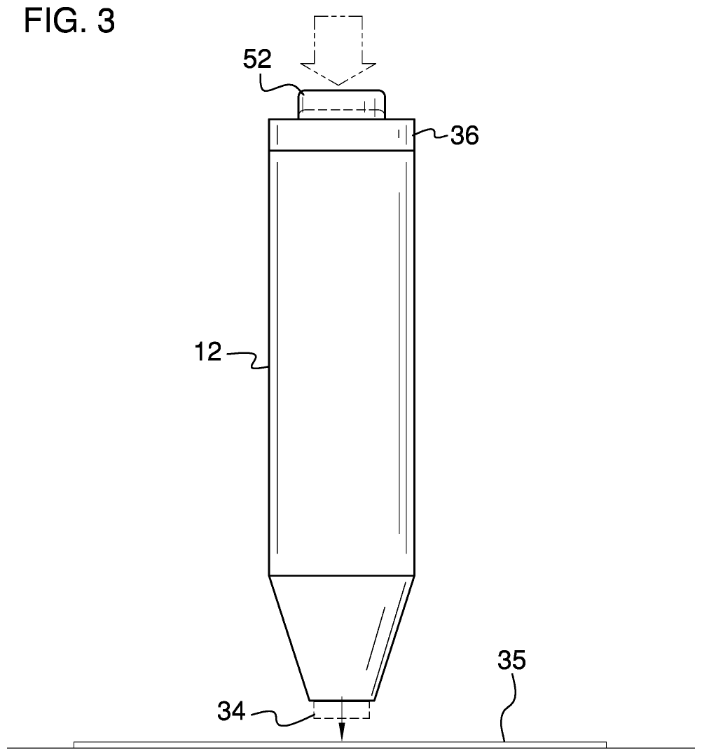

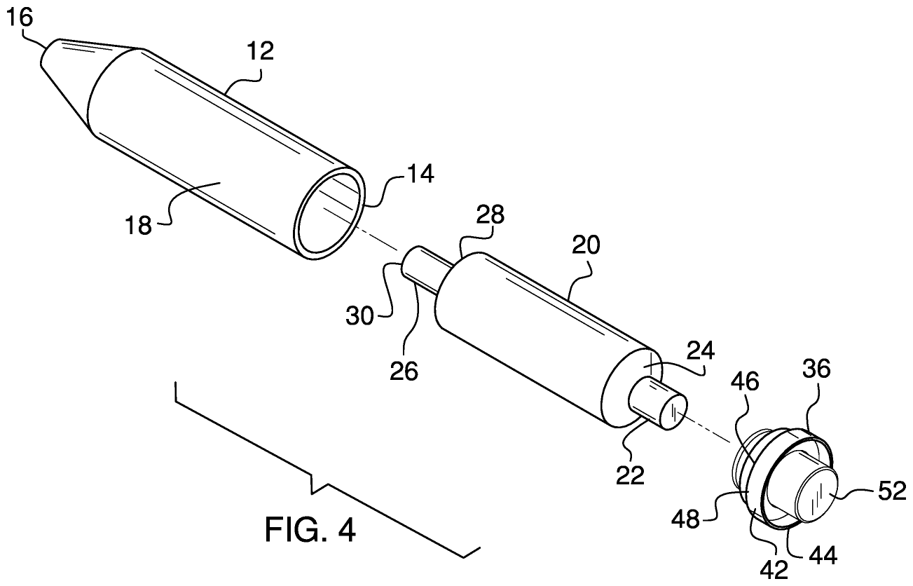

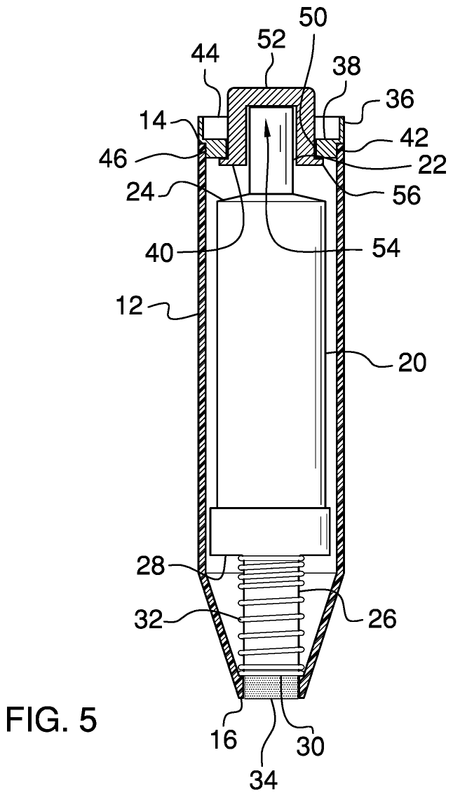

With reference now to the drawings, and in particular to FIGS. 1 through 5 thereof, a new marker device embodying the principles and concepts of an embodiment of the disclosure and generally designated by the reference numeral 10 will be described.

As best illustrated in FIGS. 1 through 5, the retractable marker assembly 10 generally comprises a tube 12 that has a tapered end such that the tube 12 has a conical shape. The tube 12 has a first end 14, a second end 16 and an outer wall 18 extending therebetween. The outer wall 18 tapers inwardly adjacent to the second end 16 such that the second end 16 has a diameter is less than a diameter of the first end 14. As is most clearly shown in FIGS. 1 and 2, the second end 16 may have an ovoid shape.

An ink cartridge 20 is provided, the ink cartridge 20 is insertable into the tube 12 and the ink cartridge 20 contains a fluid ink. The ink cartridge 20 has a stem 22 extending away from a top end 24 of the ink cartridge 20. Additionally, the ink cartridge 20 has an outlet 26 extending away from a bottom end 28 of the ink cartridge 20 and the outlet 26 passes the fluid ink outwardly therefrom. The ink cartridge 20 is insertable into the first end 14 of the tube 12 having the outlet 26 being directed toward the second end 16 of the tube 12. The outlet 26 has a distal end 30 with respect to the bottom end 28 of the ink cartridge 20. Additionally, the ink cartridge 20 is slidable toward or away from the second end 16 of the tube 12.

A biasing member 32 is provided and the biasing member 32 is positioned around the stem 22. The biasing member 32 engages the second end 16 of the tube 12 when the ink cartridge 20 is inserted into the tube 12. Moreover, the biasing member 32 biases the stem 22 inwardly into the tube 12. The biasing member 32 may comprise a spring that surrounds the stem 22.

An applicator 34 is fluidly coupled to the ink cartridge 20 and the applicator 34 is comprised of a fluid permeable material. In this way the applicator 34 can absorb the fluid ink contained in the ink cartridge 20. The applicator 34 is positioned on the distal end 30 of the outlet 26. The applicator 34 is extendable outwardly through the second end 16 of the tube 12 when the ink cartridge 20 is slid toward the second end 16. In this way the applicator 34 is exposed for pressing against a surface 35 to mark the surface 35. The applicator 34 is retracted into the second end 16 of the tube 12 when the ink cartridge 20 is slid away from the second end 16 to inhibit the applicator 34 from making a mark.

As is most clearly shown in FIGS. 1 and 2, the applicator 34 may have an ovoid shape that matches the shape of the second end 16 of the tube 12. In this way the applicator 34 can fill oval shaped bubbles on an election ballot, a standardized test answer sheet or other type of questionnaire that has multiple choice questions. Thus, the applicator 34 can fill selected oval shaped bubbles in a single motion rather than requiring a user to fill in the selected oval shaped bubble with a pencil or other writing utensil.

A cap 36 is provided and the cap 36 is removably attached to the tube 12. The cap 36 has a top side 38, a bottom side 40 and a perimeter side 42 extending therebetween. The top side 38 has a lip 44 extending upwardly therefrom and the lip 44 is coextensive with a perimeter of the cap 36. The perimeter side 42 has a recess 46 extending from the bottom side 40 toward the top side 38. A bounding surface 48 of the recess 46 rests on the first end 14 of the tube 12 when the cap 36 is positioned in the first end 14. The cap 36 has a hole 50 extending through the top side 38 and the bottom side 40, and the hole 50 is centrally positioned on the cap 36.

A button 52 slidably extends through the cap 36 and the button 52 engages the ink cartridge 20. The applicator 34 extends outwardly from the tube 12 when the button 52 is depressed. Conversely, the applicator 34 is retracted into the tube 12 when the button 52 is not depressed. The button 52 extends through the hole 50 in the cap 36 and the button 52 has a stem space 54 therein. The stem space 54 insertably receives the stem 22 on the ink cartridge 20 when the cap 36 is positioned on the tube 12. The button 52 has an engagement 56 extending outwardly therefrom. The engagement 56 abuts the bottom side 40 of the cap 36 when the button 52 is not depressed to inhibit the button 52 from being removed from the hole 50.

In use, the button 52 is depressed to extend the applicator 34 outwardly from the tube 12. In this way the applicator 34 can be depressed against the surface 35 to leave a mark on the surface 35. The applicator 34 is retracted into the tube 12 when the button 52 is released. In this way the applicator 34 is inhibited from making a mark. The retractable marker assembly can be employed for filling out an election ballot, for filling out a multiple choice answer sheet or any other similar type of questionnaire.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A retractable marker assembly being configured to make a mark of a pre-determined shape on a surface, said assembly comprising:
a tube having a tapered end such that said tube has a conical shape;
an ink cartridge being insertable into said tube, said ink cartridge containing a fluid ink, said ink cartridge being slidable between an extended position or a retracted position;
an applicator being fluidly coupled to said ink cartridge, said applicator being comprised of a fluid permeable material wherein said applicator is configured to absorb the fluid ink contained in said ink cartridge for marking a surface when said ink cartridge is in said extended position;
a cap being removably attached to said tube;
a button slidably extending through said cap, said button engaging said ink cartridge, said ink cartridge being positioned in said extended position exposed when said button is depressed having said applicator being exposed, said ink cartridge being positioned in said retracted position when said button is not depressed having said applicator being withdrawn into said tube.

2. The assembly according to claim 1, wherein:
said tube has a first end, a second end and an outer wall extending therebetween, said outer wall tapering inwardly adjacent to said second end such that said second end has a diameter being less than a diameter of said first end; and
said ink cartridge has a stem extending away from a top end of said ink cartridge, said ink cartridge having an outlet extending away from a bottom of said ink cartridge, said outlet passing the fluid ink outwardly therefrom, said ink cartridge being insertable into said first end of said tube having said outlet being directed toward said second end of said tube, said outlet having a distal end with respect to said bottom end of said ink cartridge, said ink cartridge being slidable toward or away from said second end of said tube.

3. The assembly according to claim 3, further comprising a biasing member being positioned around said stem, said biasing member engaging said second end of said tube when said ink cartridge is inserted into said tube, said biasing member biasing said stem into said tube.

4. The assembly according to claim 2, wherein said applicator is positioned on said distal end of said outlet, said applicator being extendable outwardly through said second end of said tube when said ink cartridge is slid toward said second end having said applicator being exposed, said applicator being retracted into said second end of said tube when said ink cartridge is slid away from said second end to inhibit said applicator from making a mark.

5. The assembly according to claim 3, wherein said cap has a top side, a bottom side and a perimeter side extending therebetween, said top side having a lip extending upwardly therefrom, said lip being coextensive with a perimeter of said cap, said perimeter side having a recess extending from said bottom side toward said top side, a bounding surface of said recess resting on said first end of said tube when said cap is positioned in said first end, said cap having a hole extending through said top side and said bottom side.

6. The assembly according to claim 5, wherein said applicator extends outwardly from said tube when said button is depressed, said applicator being retracted into said tube when said button is not depressed, said button extending through said hole in said cap, said button having a stem space therein, said stem space insertably receiving said stem on said ink cartridge when said cap is positioned on said tube, said button having an engagement extending outwardly therefrom, said engagement abutting said bottom side of said cap when said button is not depressed to inhibit said button from being removed from said hole.

7. A retractable marker assembly being configured to make a mark of a pre-determined shape on a surface, said assembly comprising:
a tube having a tapered end such that said tube has a conical shape, said tube having a first end, a second end and an outer wall extending therebetween, said outer wall tapering inwardly adjacent to said second end such that said second end has a diameter being less than a diameter of said first end;
an ink cartridge being insertable into said tube, said ink cartridge containing a fluid ink, said ink cartridge having a stem extending away from a top end of said ink cartridge, said ink cartridge having an outlet extending away from a bottom of said ink cartridge, said outlet passing the fluid ink outwardly therefrom, said ink cartridge being insertable into said first end of said tube having said outlet being directed toward said second end of said tube, said outlet having a distal end with respect to said bottom end of said ink cartridge, said ink cartridge being slidable toward or away from said second end of said tube;
a biasing member being positioned around said stem, said biasing member engaging said second end of said tube when said ink cartridge is inserted into said tube, said biasing member biasing said stem into said tube;
an applicator being fluidly coupled to said ink cartridge, said applicator being comprised of a fluid permeable material wherein said applicator is configured to absorb the fluid ink contained in said ink cartridge, said applicator being positioned on said distal end of said outlet, said applicator being extendable outwardly through said second end of said tube when said ink cartridge is slid toward said second end having said applicator being exposed wherein said applicator is configured to be pressed against a surface for marking the surface, said applicator being retracted into said second end of said tube when said ink cartridge is slid away from said second end to inhibit said applicator from making a mark;
a cap being removably attached to said tube, said cap having a top side, a bottom side and a perimeter side extending therebetween, said top side having a lip extending upwardly therefrom, said lip being coextensive with a perimeter of said cap, said perimeter side having a recess extending from said bottom side toward said top side, a bounding surface of said recess resting on said first end of said tube when said cap is positioned in said first end, said cap having a hole extending through said top side and said bottom side; and
a button slidably extending through said cap, said button engaging said ink cartridge, said applicator extending outwardly from said tube when said button is depressed, said applicator being retracted into said tube when said button is not depressed, said button extending through said hole in said cap, said button having a stem space therein, said stem space insertably receiving said stem on said ink cartridge when said cap is positioned on said tube, said button having an engagement extending outwardly therefrom, said engagement abutting said bottom side of said cap when said button is not depressed to inhibit said button from being removed from said hole.
